(19) United States
(12) Patent Application Publication
(10) Pub. No.: US 2017/0064451 A1
(43) Pub. Date: Mar. 2, 2017

(54) UBIQUITOUS SENSING ENVIRONMENT

(71) Applicant: New York University, New York, NY (US)

(72) Inventor: Tae Hong Park, New York, NY (US)

(21) Appl. No.: 15/244,464

(22) Filed: Aug. 23, 2016

Related U.S. Application Data
(60) Provisional application No. 62/209,542, filed on Aug. 25, 2015.

(51) Int. Cl. H04R 3/12; H04H 60/04; H04R 1/08; H04R 29/00; G06F 3/16

(52) U.S. Cl. CPC H04R 3/12; H04R 29/00; G06F 3/165; H04R 1/08; H04H 60/04

(57) ABSTRACT

A system and method for selection and distribution of information from one or more remote sensing devices that are distributed in a space. Receiving such information from the remote sensing devices and receiving a request for at least some portion of the information received from the remote sensing devices. Sending out at least some portion or all of the information to a requestor (client). The information may be comprised of audio information and may be a custom audio mix. The custom audio mix may be based on a position selected within the designated space or a location based on any location within the sensing range of one or more of the remote sensing devices.

### CROSS-REFERENCE TO RELATED PATENT APPLICATION

This application claims the benefit of U.S. Provisional Application No. 62/209,542, filed on Aug. 25, 2015, which is hereby incorporated by reference in its entirety.

### BACKGROUND OF THE INVENTION

Consumers of media often experience the media in a manner where it has been recorded live in the form of videos and/or audio files. This media may be pre-recorded or streamed in real time, close to real time, with some amount of latency, downloaded for offline usage, or a combination of the aforementioned methods among other methods. Generally, however, the consumers of such media have little or no control over their sensory experience during the viewing to, listening to, or engaging with the performance or session. While such performances may be recorded with multiple microphones and/or cameras in order to create such effects as stereo or surround sound, the listener is generally given one or limited choices on their experience which is generally dissimilar to the experience of physically being present in the venue where the event takes place.

### SUMMARY OF THE INVENTION

It is desirable to have systems and methods that allow for a user to experience a sensory environment such as a musical performance, virtually from any location within various types of spaces, for example, a stage. Such systems and methods may allow, for example, a listener to be “virtually” situated in any part of the stage of an orchestra. Perhaps they wish to be able to listen to and feel what a particular violinist, trumpet player or other on-stage performer is experiencing during the performance, or perhaps they wish to experience what the conductor is experiencing. There may even be a desire to experience the performance in a way that would not have been physically possible even if attending in person. Such sensory experiences are not limited to auditory senses, but may extend to other senses such as touch, taste, sight, or smell.

In one implementation, a server may receive data from one or more remote sensing devices (RSDS). The RSDS are also described in co-pending application number 14/629,312, which is hereby incorporated by reference. The RSDS may be distributed throughout a designated space. The server may receive a request for at least some portion of the information received from the RSDS. The server may then send all or at least some portion of the information to the requestor. The content of the information may be based on the request. Further, the information may be comprised of audio information and/or positional information of each RSD. The information may also be in the form of machine and/or human analysis results including musical note duration, pitch, dynamics, and other data measureable, extractable, and inferable from the data captured by the RSDS. Human analysis data may further be provided—data that is difficult to quantify with machines such as emotive descriptions. The information sent to the requestor may be a custom audio mix based on the request. The creation of the custom audio mix may be based on a position selected within the designated space or a position based on any location within the sensing range of one or more of the RSDS. This may include focusing on the brass section or the inverse—“removing” the brass section and focusing on all of the other, non-brass instruments. Any data transmission combination may be possible and any data type may be transmittable, including audio data, data from machine analyses, data from human annotations, visualizations, data extracted from RSDS, a combination of the aforementioned, and other data modalities from libraries and/or from other databases including data from various sources on the Internet.

In another implementation, the server creates a custom audio mix based on the selection of one or multiple “observation” positions within a space or a number of spaces. In another implementation, the sonic delays and dynamic attenuation are calculated to model and fold-in acoustic delay and acoustic energy dissipation based on the distance of each of the RSDS to the position selected within the space. The position or positions may also be based on any location within the sensing range of one or more of the RSDS.

In another implementation, the server may send information back to at least one of the RSDS or to all of the RSDS. The instruction may provide configuration information to the RSDS or result in the generation of a sound impulse by one or more of the RSDS.

In another implementation, the server may send an instruction to each RSD in turn to generate a sound impulse with the remaining RSDS capturing and sending the resulting audio information back to the server. The server may use the resulting audio information gathered to determine the relative position of each of the RSDS to the other RSDS or to determine the approximate relative position of each of the RSDS to the other RSDS. RSDS may also in part or fully contribute to the computations necessary for the sensor network and client interaction, thereby providing and distributed computing design for effective, efficient, and robust signal processing and environmental sensing.

In another implementation, the server creates a custom audio mix based on the selection of a position within a space, where the target position can coincide with the position of one of the coordinates of existing RSDS or any other location by calculating the acoustic delay and acoustic energy dissipation based on the distance of each of the RSDS to the position selected. A simple example: if a target observation position is on a “line” and between two RSDS (RSD_left and RSD_right), 50% of each RSD will contribute to the custom mix with appropriate delay as computed via linear or non-linear distance calculation algorithms from each RSD. The resulting mix can be computed by considering acoustic energy dissipation and delay as a function of distance, temperature, humidity, as well as other spatial information. Utilizing the multiple audio signals and channels, instrument isolation may also be implemented. Using information from surrounding RSDs, any particular RSD's signal may be “soloed” by using source-separation techniques where, for example, the sound of violin A may be isolated by taking into account the RSD A and its neighboring RSDs, creating a “solo” performance of violin A.

In another implementation, one embodiment is a server (or plurality of servers) and a plurality of RSDs distributed in a space. Each RSD may be comprised of a sensor, multiple types of sensors, such as a microphone and have a data connection to the server and/or between RSDs. Each RSD may be capable of sending data—such as audio data—over the data connection to the server and/or between RSDs.

In another implementation, the RSD data, including audio signals may be synchronized using a master timestamp—e.g. generated on a server. Participating RSDs will synchronize to this master timestamp/clock, which is broadcast to RSDs, allowing accurate temporal RSD alignment. Synchronization may be as part of a sensor network setup sequence where, before audio capturing/streaming occurs, network latency between each individual RSD and server, as well as bandwidth, are considered. Synchronization may also be continually adjusted during the recording/streaming phase.

In another implementation, one embodiment is a server (or plurality of servers) and plurality of RSDs distributed in a space. Each RSD may be comprised of two or more microphones forming a microphone array and have a data connection to the server. Each RSD may be capable of sending audio data over the data connection to the server in full duplex format. The microphones may be independently configurable and adjustable to provide custom directionality. The RSDs may further have an attached clamp. The clamp may be configured to attach to a music stand with a locking mechanism. The locking mechanism may be a rotating locking mechanism that will afford a secure attachment to a music stand. The locking mechanism may contain a spring system to allow for flexible adjustment of the clamp for different thickness surfaces, e.g., different music stands. The clamp may be configured to attach magnetically. The clamp may attach via a screw, e.g. a screwed connection to a music stand. The clamping mechanism may be configured to attach to various portions of a music stand. The clamp may also be attached with other non-permanent and permanent adhesives such as hook-and-loop fasteners, VELCRO®.

In another implementation, one embodiment is a server (or plurality of servers) and a plurality of RSDS distributed in a space. Each RSD may be comprised of one or more microphones and has a data connection to the server. Each RSD may be capable of sending audio data over the data connection to the server in full duplex format. Each RSD may contain a microprocessor, a communication module, various I/O, and a power source. The communication module is configured to communicate using the data connection to the server. Each RSD may contain one or more loudspeakers. The data connection between each RSD and the server may be wireless.

The foregoing summary is illustrative only and is not intended to be in any way limiting. In addition to the illustrative aspects, embodiments, and features described above, further aspects, embodiments, and features will become apparent by reference to the following drawings and the detailed description.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

FIG. 1 illustrates one implementation of a ubiquitous listening environment being used with an orchestra.

FIG. 2 illustrates an example of an interface demonstrating the placement of a virtual listening location.

FIG. 3 illustrates an example of a control panel interface.

FIG. 4 illustrates an example of a control panel interface designating multiple virtual listening locations

FIG. 5 illustrates an example of a control panel interface controlling an RSD with four microphones including gain controls.

FIG. 6 illustrates a music stand with attached RSD, side view.

FIG. 7 illustrates a music stand with attached RSD, front view.

FIG. 8 illustrates an RSD with a clamp mechanism with spring system.

FIG. 9 illustrates an RSD with a clamp mechanism with a lock mechanism in open position.

FIG. 10 illustrates a simple clamp mechanism without a locking part.

FIG. 11 illustrates a clamp mechanism with a screw.

FIG. 12 illustrates a magnetic clamping mechanism for metallic objects.

FIG. 13 illustrates a side view of an adjustable microphone implementation.

FIG. 14 illustrates a side view of an angular adjustment of microphones.

FIG. 15 illustrates a top view of an angular adjustment of microphones.

FIG. 16 illustrates an impulse burst of a single RSD being measured by all other RSDS.

FIG. 17 illustrates a charging station of RSDS in the form of a music stand cart.

FIG. 18 illustrates a music stand with power cable leading to RSD.

FIG. 19 illustrates a cart base used for charging.

FIG. 20 illustrates a mechanism for inductive charging.

FIG. 21 illustrates a computer system for use with certain implementations.

### DETAILED DESCRIPTION OF THE PREFERRED EMBODIMENTS

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

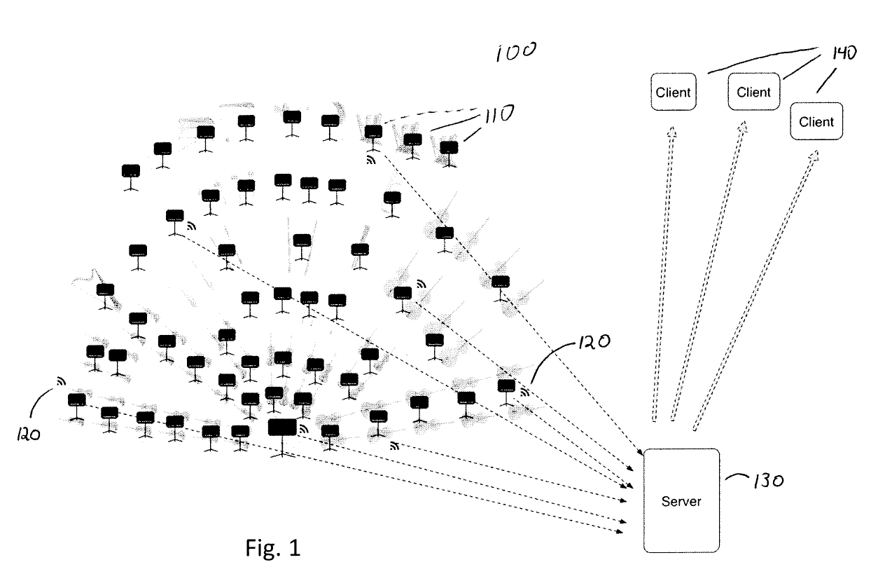

In one implementation, a server may receive from one or more remote sensing devices' (RSDS) data and information. FIG. 1 shows a representative environment 100 consisting of a space being used by an orchestra. The orchestra of FIG. 1 is depicted as using music stands 110, each music stand 110 may contain an RSD 120, or some sampling of each music stand 110 may contain an RSD 120. The RSDS 120 may be distributed throughout the space, such as in a defined subspace within the space. FIG. 1 shows a server 130 which may receive a request for at some portion of the information received from the RSDS 120. The server 110 may then send all or at least some portion of the information to the requestor. FIG. 1 shows some representative requestors in the form of clients 130. The content of the information may be based on the request. Further, the information may be comprised of audio information, positional information, and other information that can be extracted from the signal captured by of each RSD 120 and also combined and analyzed with other data modalities via internal databases or external databases including libraries and the Internet itself. The information sent to the requestor may be a custom audio mix based on the request. The creation of the custom audio mix may be based on a position selected within the designated space or a position based on any location within the sensing range of one or more of the RSDS 120. The information can also be from multiple locations streamed simultaneously. The information can also be from a position that is beyond the “stage”—60^{th} row at the corner of a concert hall, for example.

In another implementation, a ubiquitous listening environment is constructed in the representative environment 100 allowing a listener to experience a musical performance—e.g. orchestra, string quartet, or rock band, etc.—from virtually “any” location on the stage. This implementation includes a single or multiple RSDS 120 and one or more servers 130 that receive audio and/or other measurements from the wireless (and/or wired) RSDS 120, which are custom and/or interactively mixed, and finally sent to clients with custom “mixes.” The RSD nodes 120 provide a close-proximity capture of audio signals from the musician behind the music stand, for example, via a single or array of microphones (and/or other sensors). One setup is shown in FIG. 1, where RSDS 120 are attached to music stands, which send captured audio signals to a server 130, and the server 130 streams custom audio mixes to clients 140. In this implementation, a listener can be virtually “situated” in any part of the stage of an orchestra allowing, for example, for a listener to be able to listen to and feel what a particular violinist, trumpet player, or any other on-stage performer may experience, including the conductor himself/herself. As shown in FIG. 1., RSDS 120 transmit measured signals to the server 130 that may be time-synchronized and delivered to clients 140 who wish to listen to a particular listening experience. The observation position can also be from multiple locations streamed simultaneously. The information can also be from a position that is beyond the “stage”—top balcony, furthest from the concert hall stage, for example.

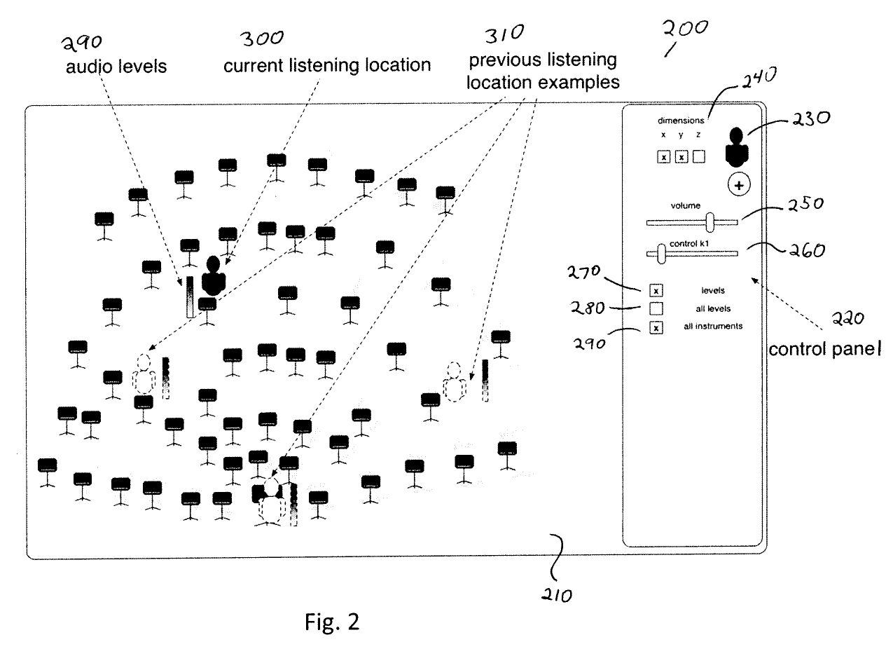

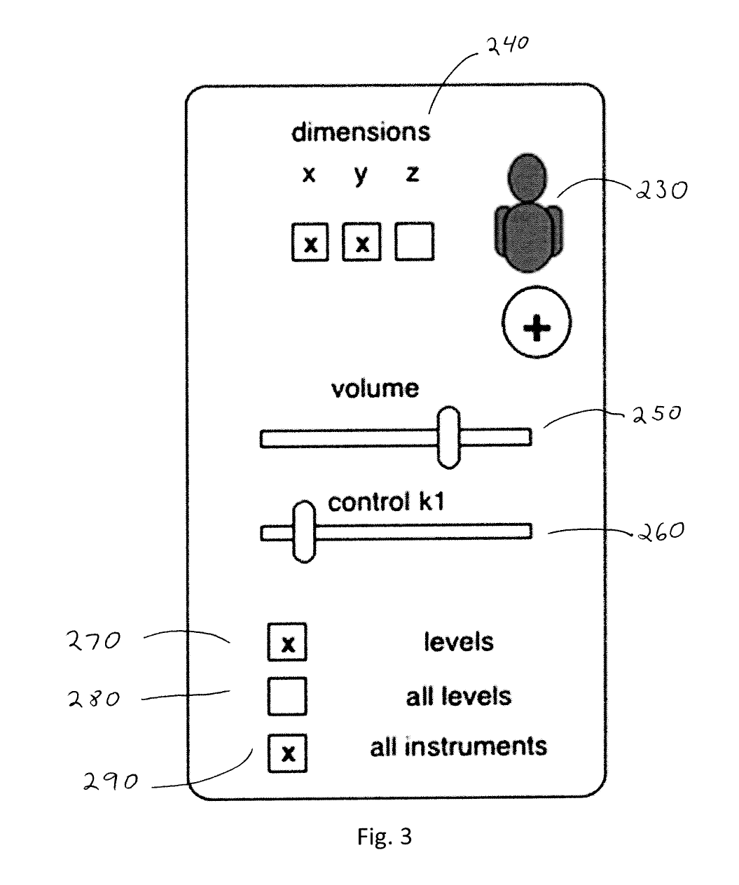

An example client interface is shown in FIG. 2. In this implementation, there is a stage 210 area and a control panel 220. The control panel 220 allows placement of an avatar 230 in the stage 210 area as defined by coordinates 240. The avatar 230 may be placed by entering coordinates 240 directly via any text input method or by dragging and dropping the avatar 230 on to the stage 210 area. The control panel 220 further allows for control of volume 250 and gain (control k1) 260 via slider controls. The control panel further allows for control of individual RSD levels 270, all RSD levels 280, and all instruments 290 through selectable checkboxes. Levels checkbox 270 may enable the display of a traditional level meter interface for a single RSD, perhaps the RSD closest to the avatar 230. A all levels checkbox 280 may enable the display of a traditional level meter interface for all RSDS or alternatively all active RSDS. All instruments checkbox 290 may turn an all RSDS for auditioning. FIG. 3 shows a larger version of the example control panel. For alternative controller interfaces—e.g. touchscreens, motion sensors, etc.—control features as introduced here, can be mapped for more natural control of observation parameters. Additionally, controls for zooming in/out scope of view, along with visual panning, and height change, are also an example of visualization control. Various implementations (not shown) in further selecting and monitoring each node may be implemented, including a zoom-in/out interaction methodology, for example, using touch-screen devices: pinching may zoom into a given node thus increasing the energy levels of a target RSD, and vice-versa, un-pinching will result in zoom-out and fold in neighboring RSD signals captured in the user's view via the touchscreen monitor.

In one implementation, the listening locations may be in the form of an Internet interface of a web-browser, standalone software application, hardware implementation, or a combination of other interaction solutions. For example, in FIG. 2, the current listening location 300 would be virtually that of the clarinetists sitting in the orchestra. The locations may be changed dynamically—i.e. in real-time so as to be able to change listening locations within a given setting (e.g. orchestra) dynamically. Additionally, the elevation dimension may be considered whereby the listener can be positioned above the orchestra: as elevation increases, neighboring RSD contributions increase as per acoustic wave transmission properties (inverse-square relation between distance and acoustic energy). These implementations may also be used in conjunction with existing, traditional microphone systems in the concert hall.

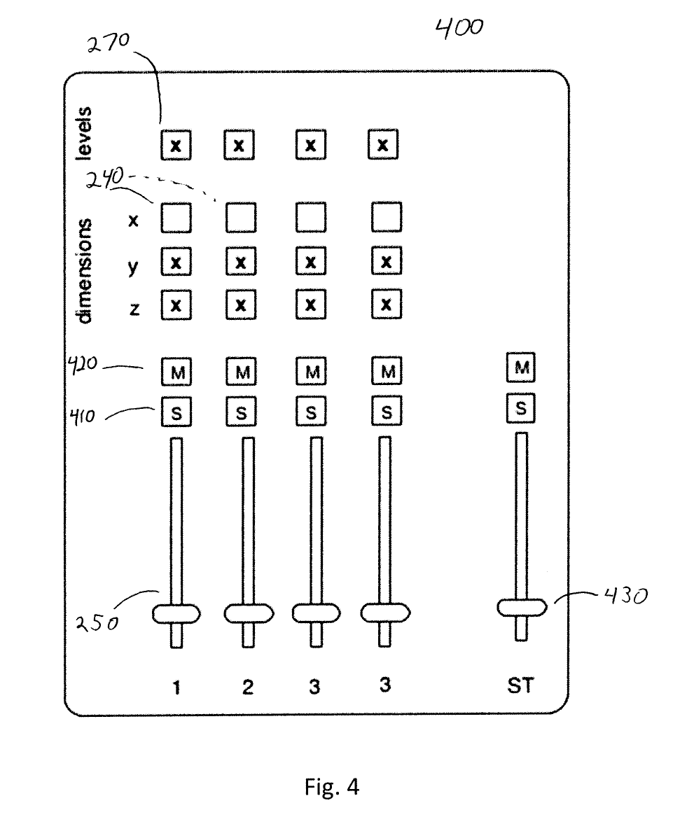

FIG. 4 shows one implementation with a more detailed view of the user control panel implementation 400 where the x, y, z checkboxes 240 allow the listener to control positioning of avatar in three dimensions where z denotes height and xy, the surface of the stage. The option of enabling/disabling one of the three dimensions can facilitate navigation as traditional computer interfaces are designed for navigating 2D spaces: e.g. a pointing devices like the computer mouse is moved over a 2D area and is not ideal for navigating 3D spaces. In an alternate implementation (not shown), the user can enter numerical values directly in to control panel to set these coordinates. Also shown in FIG. 4 are slider examples where in one implementation the “volume” of listening location can be adjusted via a volume slider 250. There are mute checkboxes 420 which can turn off the audio from that particular RSD. The solo checkbox 410 will only enable one RSD and mute all other RSDS. The mute buttons can be used to “mute” the contributions of a select set of RSDS in the custom mix. Each RSD may have its own set of levels checkbox 270, coordinates 240, mute checkbox 420, solo checkbox 410 and volume slider 250. Also shown is a master output level control (ST) 430 with corresponding volume slider 250, mute checkbox 420 and solo checkbox 410. Returning to FIG. 2, audio levels of RSD node (enabled via the level checkbox 270) are displayed in a traditional level meter interface. Other interface implementations include “all levels” 280 which displays all audio levels of all RSDS and “all instruments” 290 which will turn on all RSDS for auditioning. In another implementation (not shown here), audio levels (and any other information) may be graphically presented through a window of time showing the change in energy levels in the first 2 minutes, for example.

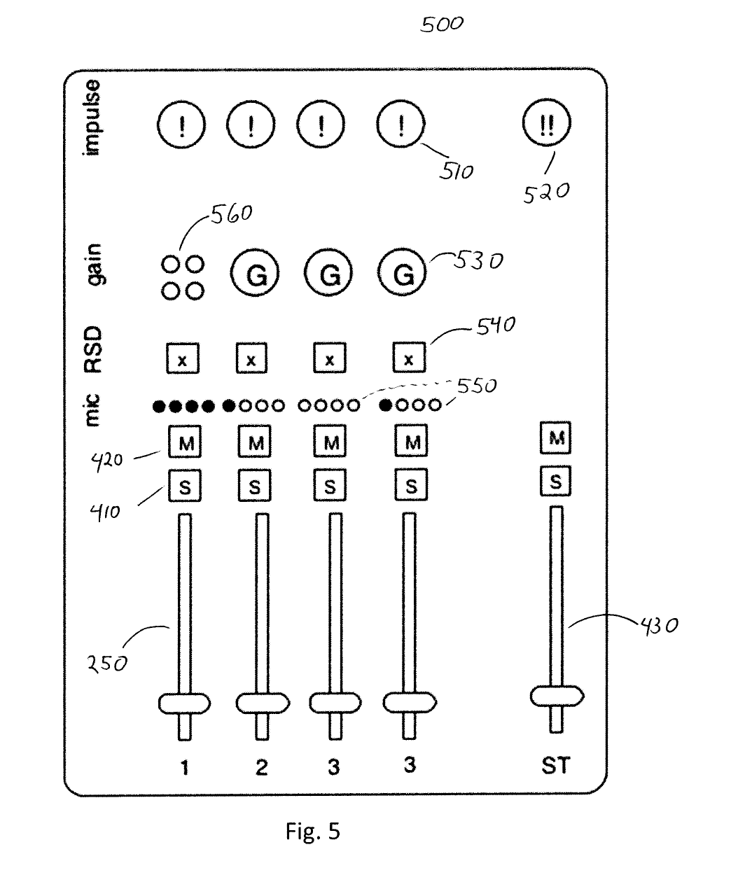

In another implementation, a user interface for adjusting and monitoring active RSDS is shown in FIG. 5 with solo (S) checkbox 410, mute (M) checkbox 420, and master output level control (ST) 430. This may be an example of a “server” control panel. The server user interface 500 is similar in function to the client user interface but also differs as it also allows control of input gain to the microphone (or microphones if more than one for a given RSD) as well a “ping” option. There may be an individual ping button 510 for each RSD and a “ping all” button 520 to ping all RSDS with an impulse of sound. For a ping, the server may send an instruction to an individual RSD to generate a sound impulse with the remaining RSDS sending the resulting captured audio information back to the server. With a “ping all”, the server may send an instruction to each RSD in turn to generate a sound impulse with the remaining RSDS sending the resulting audio information back to the server. The server may use the resulting audio information gathered to determine the relative position of each of the RSDS to the other RSDS or to determine the approximate relative position of each of the RSDS to the other RSDS. This can be used to automatically or semi-automatically position the RSDS in the visualization of the orchestra, for example, as the layout of the RSDS (via music stands) may change from performance to performance.

The gain knob 530 controls the input gain to the microphone sensor, which remotely controls the microphone amplification gain on the RSD side. The RSD checkbox 540, turns on/off an RSD and a row of LEDs 550 indicates online status of a given RSD and its number of microphones with one LED for each microphone (shown here with four microphones per RSD).

In another implementation, the acoustic environment in a given location is simulated by considering all of the active RSD signals, their location (angle and distance), artificial acoustic delay governed by parameters such as distance (inverse square law), speed of sound, temperature, humidity, and architectural details governing given space and selected observation location. That is, the audio output will be a sum of all RSD signals at a given location by considering distance, angle, energy dissipation as well as other parameters including ones outlined above. For example, as temperature may change over the course of a performance, computation of custom mix may also change accordingly.

Returning to FIG. 1, the server 130 may create a custom audio mix based on the selection of a position or positions within a space by calculating the acoustic delay and acoustic energy dissipation based on the distance of each of the RSDS 120 to the position selected within the space 100 (other environmental elements may also be considered as outlined above). The position may also be based on any location within the sensing range of one or more of the RSDS 120.

In another implementation, the server 130 may send information back to at least one of the RSDS 120 or to all of the RSDS 120. The instruction may provide configuration information to the RSDS 120 or result in the generation of a sound impulse by one or more of the RSDS. The server 130 may send an instruction to each RSD 120 in turn to generate a sound impulse with the remaining RSDS 120 sending the resulting audio information back to the server 130. The server 139 may use the resulting audio information gathered to determine the relative position of each of the RSDS 120 to the other RSDS 120 or to determine the approximate relative position of each of the RSDS 120 to the other RSDS 120. FIG. 5. shows a user interface with individual impulse buttons 510 or a “ping all” button 520 which may provide an impulse to each RSD 120 in turn. These impulse signals can also be utilized in capturing the spatial characteristics of a concert space, for example, which can then be used for convolution-based reverb algorithms.

In another implementation, the server 130, shown in FIG. 1 creates a custom audio mix based on the selection of a position (or positions) within a space, where the position coincides with the position of one of the RSDS 120, by calculating the acoustic delay and acoustic energy dissipation based on the distance of each of the RSDS 120 to the position selected (other environmental elements may also be considered as outlined above). The server 130 may also isolate the “strongest” audio information in the immediate range of the position coinciding with one of the RSDS 120 and subtract out the audio information of the remaining one or more RSDS 120 based on calculating the acoustic delay, acoustic energy dissipation on the distance of each of the remaining RSDS 120, as well as via source separation techniques, to the selected RSD. This would result in the creating of an audio mix that is a “solo” performance of the immediate area around the selected RSD.

### Hardware Implementation

As shown in FIG. 1 in one implementation using a stage representative environment 100 and stage hardware, RSDS can be attached to commonly existing stage hardware including, but not limited to, music stands 110. Other examples of stage equipment where they may be attached may include microphone stands, guitar stands, chairs, or an instrument itself, as part of a hand-held device, on the performer's body, etc.

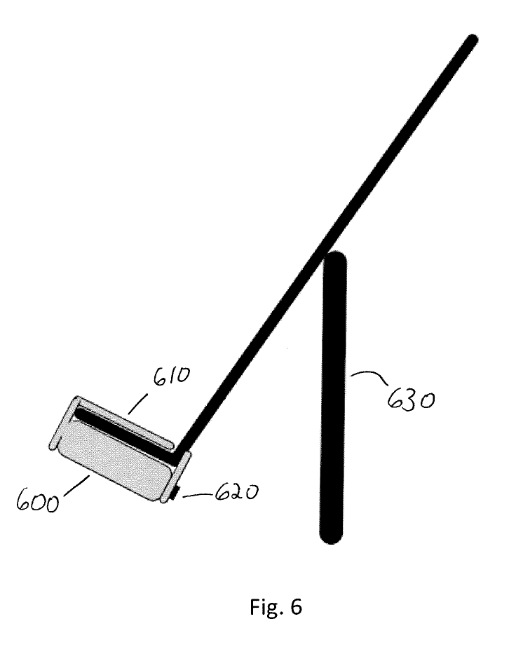

FIG. 6 shows a side view of one implementation where the RSD package main body 600 is attached at the bottom of the music stand 630 with an attached clamp mechanism 610 as well as a clamp locking mechanism 620. This may allow for a secure, convenient, non-obtrusive, and easy to use music stand where the music stand's original functionality remains intact with no physical alteration the music stand 630 itself.

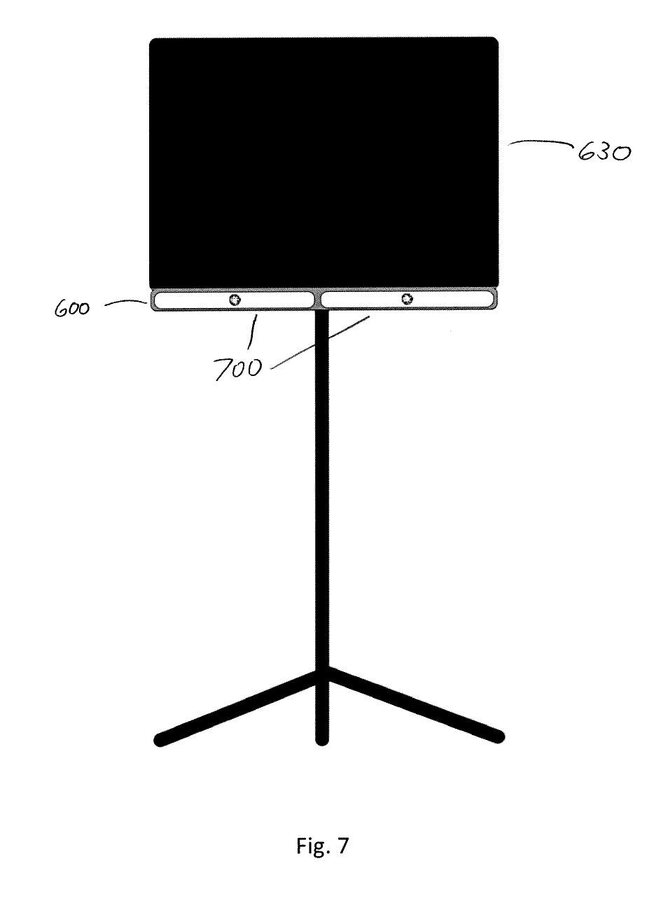

FIG. 7 shows a front view of one implementation where the RSD package 600 is attached at the bottom of the music stand 630 showing two front microphones 700.

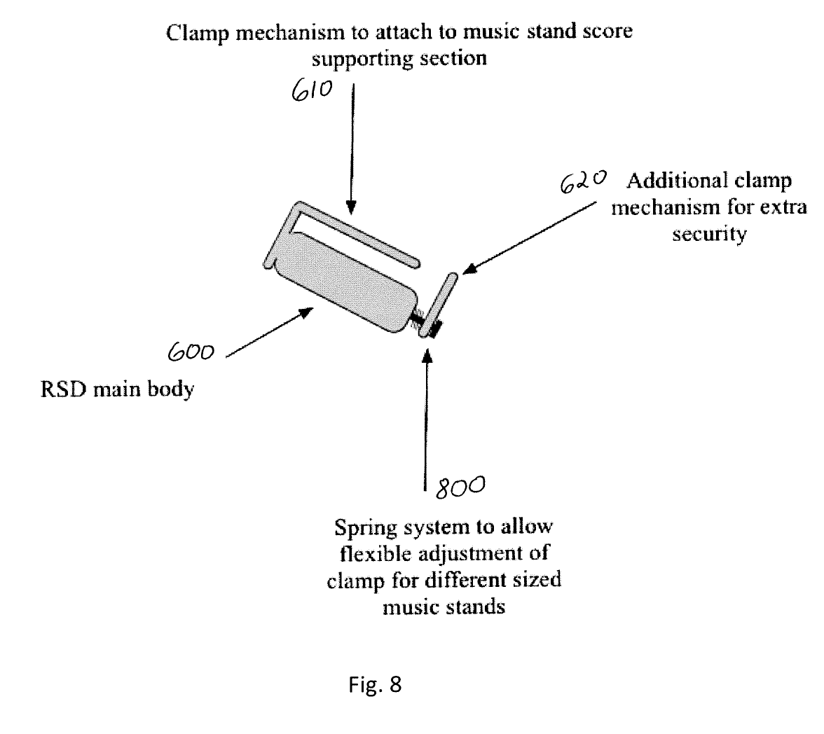

FIG. 8 shows a side view of another implementation of the RSD package with the RSD main body 600 attached to a clamp mechanism 610 with the additional clamp locking mechanism 620. In addition, there is a spring system 800 to allow for the adjustment of the additional clamp locking mechanism 620 for different sized or thickness music stands. The spring system 800 and clamp locking mechanism 620 is shown in a secured/locked position.

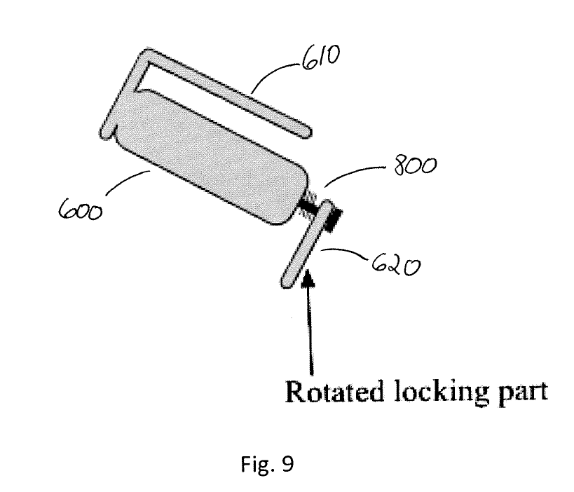

FIG. 9 shows the implementation of FIG. 8 with a side view of spring system 800 and clamp locking mechanism 620 rotated to be in an open position.

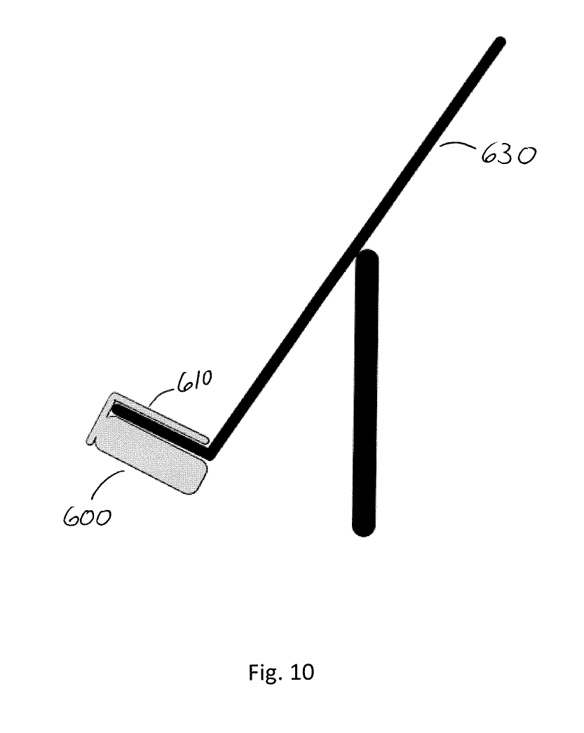

FIG. 10 shows a side view of an implementation of a simple clamping mechanism with only the RSD package main body 600 attached to the music stand 630 with an attached clamp mechanism 610. The clamping mechanism may also be surfaced or produced with dampening and/or, sound absorption materials in order to lessen vibrations that originate from the music stand.

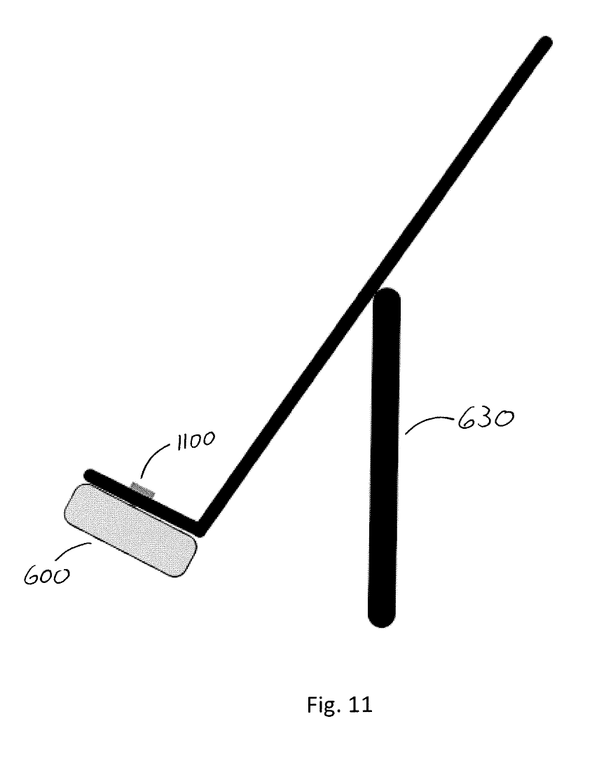

FIG. 11 shows a side view of an implementation of a clamping mechanism with only the RSD package main body 600 attached to the music stand 630 with a screw 1100.

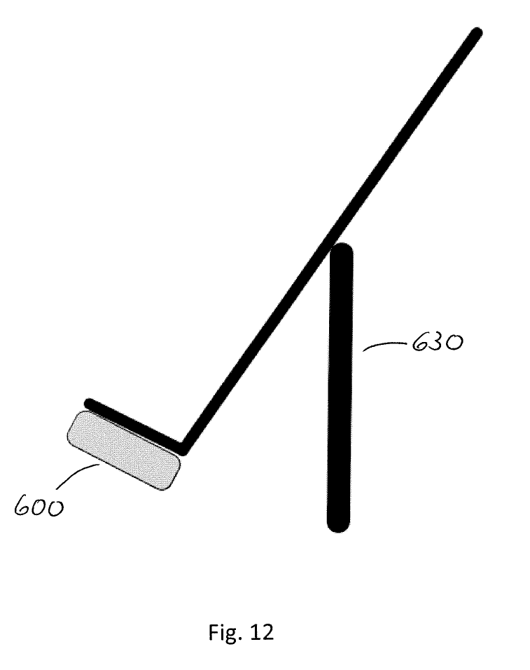

FIG. 12 shows a side view of an implementation of a clamping mechanism with only the RSD package main body 600 attached to the music stand 630 with a magnetic clamping mechanism (not shown).

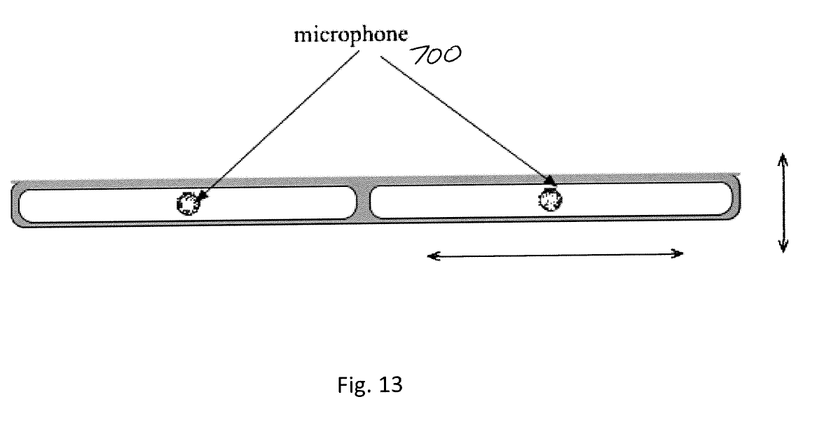

FIG. 13 shows a front view of an implementation of the RSD package main body 600 with integrated microphones 700

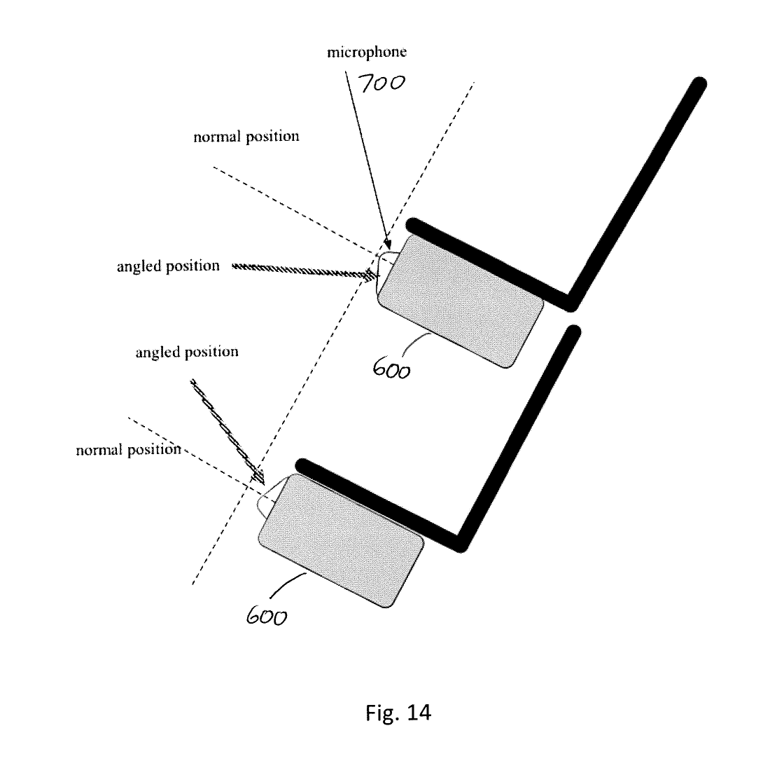

FIG. 14 shows a side view of an implementation of the RSD package main body 600 with integrated microphones 700 showing possible angular adjustment of the microphones 700 via vertical panning.

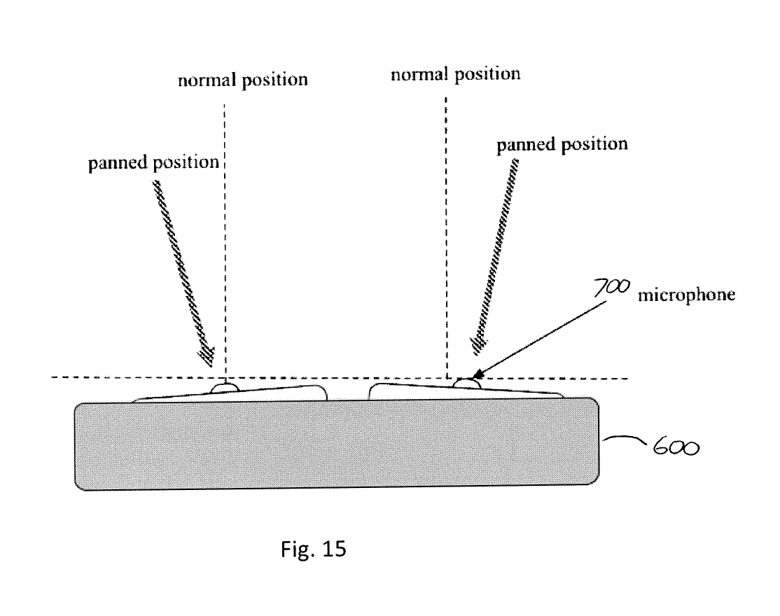

FIG. 15 shows a top view of an implementation of the RSD package main body 600 with integrated microphones 700 showing possible angular adjustment of the microphones 700 via horizontal panning.

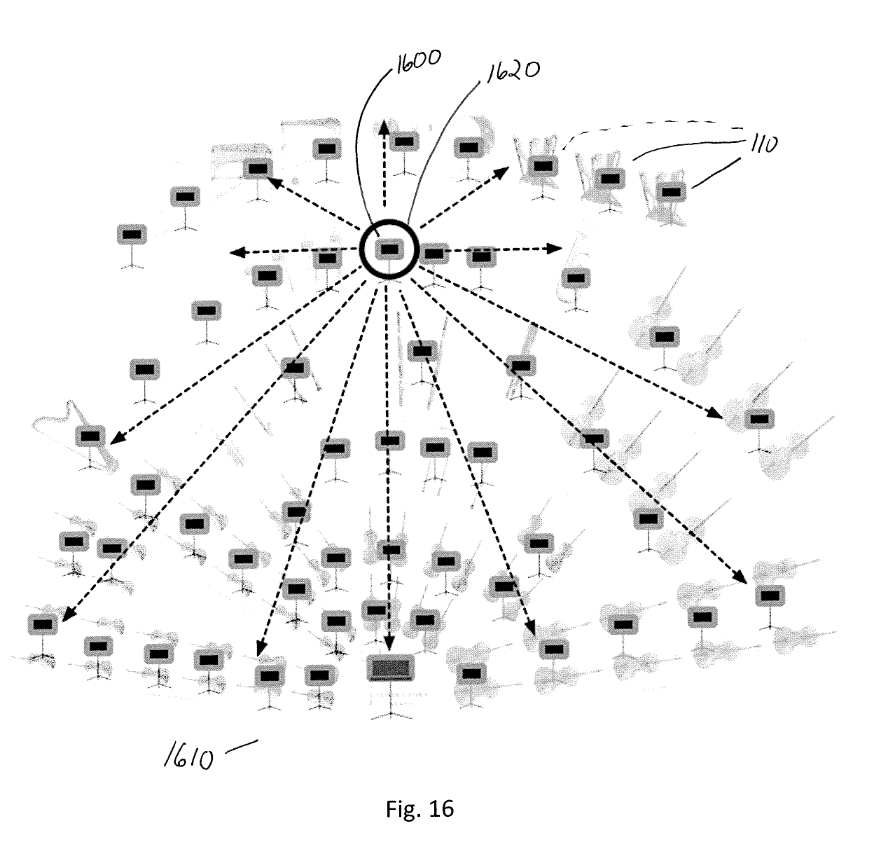

FIG. 16 shows an impulse burst of sound 1620 from a single RSD 1600 and all other RSDS 1610 measuring or recording the sound generated from the impulse burst of sound 1620. The impulse burst may be created by sending a “ping” to the single RSD 1600. For a ping, the server (shown in FIG. 1) may send an instruction to a single RSD to generate a sound impulse with the remaining RSDS 1610 sending the resulting audio information back to the server. With a “ping all”, the server may send an instruction to each RSD in turn to generate a sound impulse with the remaining RSDS sending the resulting audio information back to the server. The server may use the resulting audio information gathered to determine the relative position of each of the RSDS to the other RSDS or to determine the approximate relative position of each of the RSDS to the other RSDS.

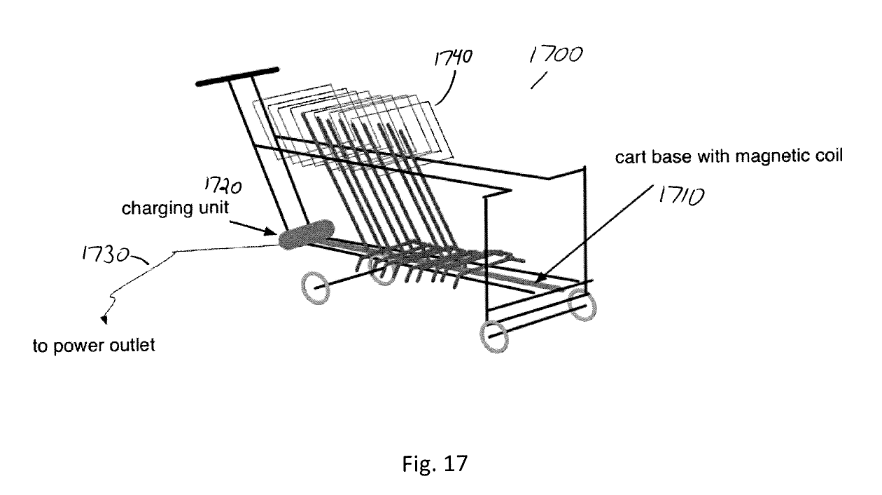

FIG. 17 shows an implementation of a charging station 1700 for use with music stands with integrated RSDS 1740 each containing a rechargeable battery. Instead of using a power cord to connect each RSD-music stand 1740 to a power outlet, a charging station in the form of a “music stand charging cart” with a cart base containing a magnetic coil 1710 is utilized with the magnetic coil charging the RSD-music stands 1740 inductively via a charging unit 1720 using a single power cord 1730 connected to a power outlet. An LED on each RSD may indicate charging initiation (in red for example) and may indicate when charging complete (in green for example). Another implementation is possible of the charging station 1700 where instead of inductive charging physical contact is accomplished between the music stand and cart cathode/anode bases via a physical locking mechanism to maintain contact (not shown). Alternatively, each RSD package may have a power cord and rechargeable battery pack that can be used to charge each music stand or the RSD package separately.

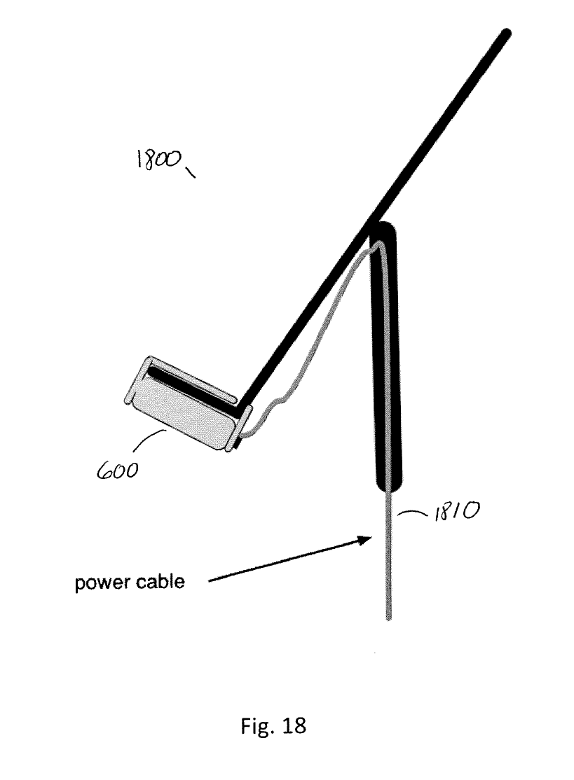

FIG. 18 shows one possible charging configuration 1800 where the RSD main body 600 is connected via a power cable 1810 to the bottom of the music stand where the slave inductor setup is located (not shown in FIG. 18).

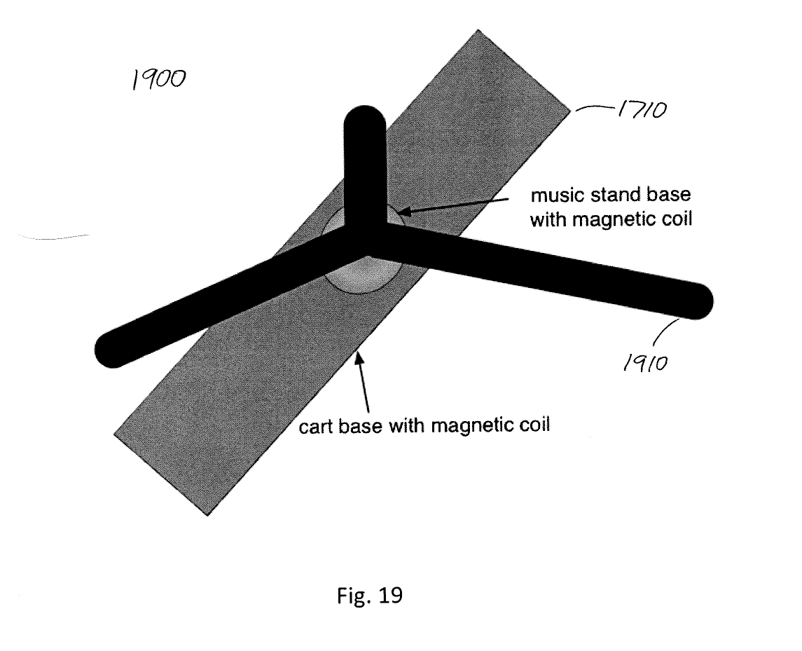

FIG. 19 shows a close-up of the an inductive charging configuration 1900 where the music stand base 1910 is located over the cart base containing the magnetic coil 1710.

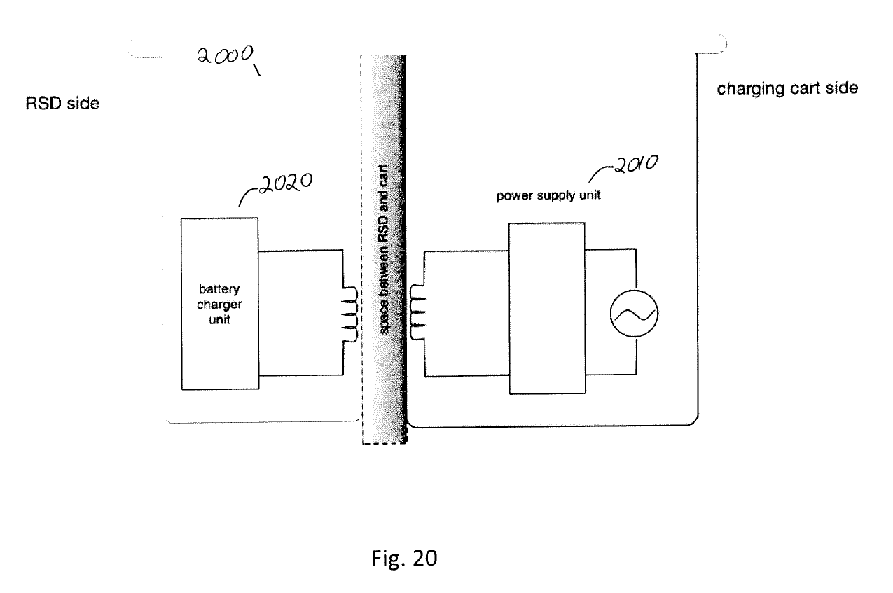

FIG. 20 shows sample circuitry 2000 that shows one configuration through which inductive charging may take place with a power supply unit 2010 located on the charging cart and a battery charger unit 2020 located on the music stand side.

In one implementation, the system and method described herein are configured for use in an audio-visual setting such as a sporting event. For example, a system could be used at the US Open for example (tennis) or other sports such as baseball, basketball, etc. A further implementation applies the system and methods described herein to remote learning, such as Internet based learning, not just for music but classrooms of every type including dance classes, art classes, traditional classes etc. In tennis, for example, the microphones can be used to determine what kind of spin is being used and also capture the vibe of the stadia. Sports that involve smaller playing surfaces or venues would be readily adaptable to the use of the technology. For example, ping-pong, others include billiard tables, etc. The idea is that any sport that has tables etc. as part of it would be an easy go-to application area.

In another implementation, a dynamic and flexible distributed sensor network is created whereby the RSDS in the sensor network actively participate in not just processing and computing its captured data but also data captured from other RSDS. In one particular implementation, the audio mix that is requested by a client is mixed fully or partially by the RSDS in the sensor network. In this example, one RSD may receive one or more audio data (and other data) from neighboring RSDS to create a subm ix as requested by the client. In this scenario, the RSDS in the sensor network may receive a submix that represent a submix of two or more RSDs which in turn will create a submix that represents a larger submix of RSDs. This allows for significant server bandwidth reduction as only a subset of RSDs (or in extreme cases) one RSD will send the overall mix of sensor network RSDs to the server. The server will then provide the final mix to the requester.

In another implementation, an RSD may be in the form of an off-the-shelf handheld device, such as a smartphone equipped with an internal microphone or high-quality external add-on microphone. In this scenario, the devices enable the creation of a virtual studio where the signals captured by the devices (RSDs) are synchronized, form a sensor network, and stream data to the server (for example, to the “cloud”). The user(s) can then access the individual audio tracks, edit, mix, and manipulate them in the cloud environment bypassing the need for the traditional digital audio workstation (DAW). In this implementation, a virtual studio is created whereby the RSDs provide the technology and means to capture high-quality audio (and any other signal depending on sensor attached), stream data to a server or multiple servers, and allow user access to the data through a standard web-browser. Further, the user would be able to download mixed, individual, and/or processed tracks, metadata, and other data such as control data to a local computer for additional editing.

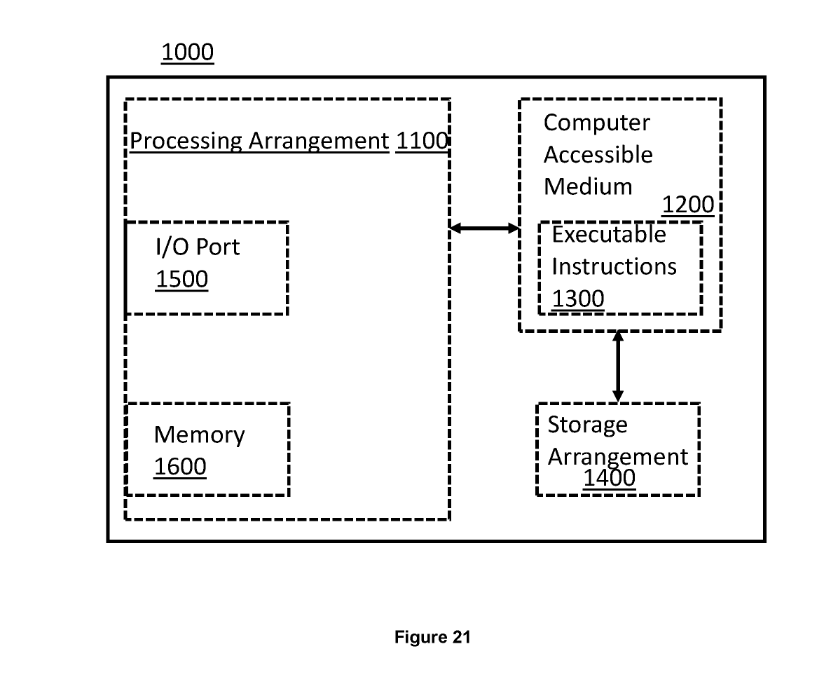

As shown in FIG. 21, e.g., a computer-accessible medium 1200 (e.g., as described herein, a storage device such as a hard disk, floppy disk, memory stick, CD-ROM, RAM, ROM, etc., or a collection thereof) can be provided (e.g., in communication with the processing arrangement 1100). The computer-accessible medium 120 may be a non-transitory computer-accessible medium. The computer-accessible medium 120 can contain executable instructions 130 thereon. In addition or alternatively, a storage arrangement 1400 can be provided separately from the computer-accessible medium 1200, which can provide the instructions to the processing arrangement 1100 so as to configure the processing arrangement to execute certain exemplary procedures, processes and methods, as described herein, for example.

System 1000 may also include a display or output device, an input device such as a key-board, mouse, touch screen or other input device, and may be connected to additional systems via a logical network. Many of the embodiments described herein may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communication protocols. Those skilled in the art can appreciate that such network computing environments can typically encompass many types of computer system configurations, including personal computers, hand-held devices, multi-processor systems, microprocessor-based or programmable consumer electronics, network PCs, minicomputers, mainframe computers, and the like. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

Various embodiments are described in the general context of method steps, which may be implemented in one embodiment by a program product including computer-executable instructions, such as program code, executed by computers in networked environments. Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps.

Software and web implementations of the present invention could be accomplished with standard programming techniques with rule based logic and other logic to accomplish the various database searching steps, correlation steps, comparison steps and decision steps. It should also be noted that the words “component” and “module,” as used herein and in the claims, are intended to encompass implementations using one or more lines of software code, and/or hardware implementations, and/or equipment for receiving manual inputs.

With respect to the use of substantially any plural and/or singular terms herein, those having skill in the art can translate from the plural to the singular and/or from the singular to the plural as is appropriate to the context and/or application. The various singular/plural permutations may be expressly set forth herein for the sake of clarity.

The foregoing description of illustrative embodiments has been presented for purposes of illustration and of description. It is not intended to be exhaustive or limiting with respect to the precise form disclosed, and modifications and variations are possible in light of the above teachings or may be acquired from practice of the disclosed embodiments. It is intended that the scope of the invention be defined by the claims appended hereto and their equivalents.

What is claimed is:

1. A method for selection and distribution of information from one or more remote sensing devices (RSDS) comprising:
receiving by a server information from one or more RSDS;
receiving by the one or more servers a request for at least some portion of the information; and
transmitting by the server the at least some portion of the information based on the request;
wherein the one or more RSDS are distributed in a space.

2. The method for selection and distribution of information from one or more RSDS of claim 1, where the information comprises audio information.

3. The method for selection and distribution of information from one or more RSDS of claim 1, where the information comprises positional information of the one or more RSDS.

4. The method for selection and distribution of information from one or more RSDS of claim 2, wherein the server streams a custom audio mix based on the request.

5. The method for selection and distribution of information from one or more RSDS of claim 4, wherein the custom audio mix is created by the server based on a position selected within the space.

6. The method for selection and distribution of information from one or more RSDS of claim 5, wherein the creation of the custom audio mix by the server comprises calculating the acoustic delay and acoustic energy dissipation on the distance of each of the one or more RSDS to the position selected within the space.

7. The method for selection and distribution of information from one or more RSDS of claim 2, further comprising the server sending an instruction to the one or more RSDS.

8. The method for selection and distribution of information from one or more RSDS of claim 7, wherein the instruction results in the generation of a sound impulse by the one or more RSDS.

9. The method for selection and distribution of information from one or more RSDS of claim 2, further comprising:
transmitting an instruction to a first RSD of the one or more RSDS by the server for the first RSD to generate a sound impulse; and
transmitting the audio information generated by the remainder of the one or more RSDS due to the sound impulse to the server;
wherein the server uses the resulting audio information as part of a calculation to determine the relative position of the first RSD.

10. The method for selection and distribution of information from one or more RSDS of claim 4, wherein the custom audio mix is created by the server based on a position selected within the space, wherein the position selected within the space coincides with the location of a selected RSD of the one or more RSDS.

11. The method for selection and distribution of information from one or more RSDS of claim 10, wherein the audio information from the selected RSD is isolated by the server subtracting the audio information of the remaining one or more RSDS based on calculating the acoustic delay and acoustic energy dissipation on the distance of each of the remaining RSDS to the selected RSD.

12. A system for a listening environment comprising:
a plurality of RSDS distributed in a space; and
a server;
wherein the plurality of RSDS are comprised of a microphone; wherein the
plurality of RSDS have a data connection to the server; and wherein audio data is sent over the data connection from the plurality of RSDS to the server.

13. The system for a listening environment of claim 12, wherein one or more of the plurality of RSDS comprises two or more microphones and at least one of a group of sensors comprising humidity, image, brightness, temperature, and scent.

14. The system for a listening environment of claim 12, wherein the server further transmits at least a portion of the audio data to a user

15. The system for a listening environment of claim 12, further comprising a clamp attached to each of the plurality of RSDS.

16. The system for a listening environment of claim 15, wherein the clamp is configured to attach to a music stand with a locking mechanism.

17. The system for a listening environment of claim 15, wherein the clamp is configured to attach to a music stand magnetically.

18. The system for a listening environment of claim 12, wherein the plurality of RSDS each are further comprised of a microprocessor, a communication module, and a power source wherein the communication module is configured to communicate using the data connection to the server.

19. The system for a listening environment of claim 18, wherein the plurality of RSDS are further comprised of a loudspeaker.

20. The system for a listening environment of claim 12, wherein the data connection to the server of the plurality of RSDS is wireless.

21. The system of claim 12, wherein the plurality of RSDS are synchronized to a master timestamp generated by the server allowing the server to align and combine the audio data sent over the data connection from the plurality of RSDS.
